(19) United States
(12) Patent Application Publication
(10) Pub. No.: US 2026/0192607 A1
(43) Pub. Date: Jul. 9, 2026

(54) COMMERCIAL-VEHICLE TYRE

(71) Applicant: Continental Reifen Deutschland GmbH, Hannover (DE)

(72) Inventor: Wilke Eikermann, Hannover (DE)

(73) Assignee: Continental Reifen Deutschland GmbH, Hannover (DE)

(21) Appl. No.: 19/133,510

(22) PCT Filed: Dec. 18, 2023
(86) PCT No.: PCT/DE2023/200258

§ 371 Date: May 28, 2025

(30) Foreign Application Priority Data
Dec. 19, 2022 (DE) 10 2022 213 922.4

(51) Int. Cl. B60C 11/13; B60C 11/03; B60C 11/12

(52) U.S. Cl. CPC B60C 11/1323; B60C 11/0323; B60C 11/1259; B60C 2011/0353; B60C 2011/0355; B60C 2011/039; B60C 2011/0397

(57) ABSTRACT

A tire wherein running at least between two profile ribs is a circumferential groove combination of two circumferential grooves which are separated from each other by a recessed rib which has an outer surface that is radially inwardly offset in relation to the outer surface of the tread by a distance of 1.5 mm to 6.0 mm and which has, at its widest point, a width of 6.00 mm to 14.00 mm. At least one of the two circumferential grooves is a circumferential groove composed, in the radial direction and in its course along the recessed rib, of a narrow groove portion that has a width of 0.8 mm to 1.5 mm and of a channel-like widening that adjoins this groove portion, has the groove base and has a width ascertained at its widest point, of 4.0 mm to 8.0 mm.

The invention relates to a commercial vehicle tire comprising a profiled tread with profile ribs having an outer surface forming the positive surface, and with circumferential grooves which extend in an encircling manner in the circumferential direction and form the main grooves of the tread, wherein running at least between two profile ribs is a circumferential groove combination of two circumferential grooves which are separated from each other by a recessed rib which has an outer surface that is radially inwardly offset in relation to the outer surface of the tread by a distance of 1.5 mm to 6.0 mm and which has, at its widest point, a width of 6.00 mm to 14.00 mm.

Commercial vehicle tires designed in this manner are known, for example, from DE 3882483T2 . This document discloses commercial vehicle tires with treads having different embodiment variants of circumferential groove combinations of two circumferential grooves which are separated from each other by a recessed rib acting as a “sacrificial rib”, and which are arranged in the tread of the tire instead of an otherwise customary circumferential groove having a V- or U-shaped cross section. In one of the embodiment variants, the two circumferential grooves are of identical construction, are designed so as to run in a mirror-symmetrical manner to each other and are either constructed, in cross section, analogously to conventionally designed circumferential grooves or are sipe-like, narrow circumferential grooves. In further embodiment variants of circumferential groove combinations, one circumferential groove is a sipe-like, narrow circumferential groove, and the other, second, circumferential groove is a wider circumferential groove which is analogous in cross section to conventionally designed grooves. A further commercial vehicle tire of the type mentioned at the outset is known from JP H0288311. The tread of this tire has, for example, at least one circumferential groove combination of a sipe-like, narrow circumferential groove and a wider circumferential groove designed to be V-or U-shaped in cross section, wherein these two circumferential grooves are separated from each other by a rib recessed in relation to the outer surface of the profile.

Circumferential groove combinations of two circumferential grooves and a recessed or lowered rib formed between them have been found to be particularly advantageous in treads of commercial vehicle tires, in particular tires used on non-driven vehicle axles, in order to avoid non-uniform wear and to ensure high mileage. The effect of lowered ribs is thus known in principle and can be summarized as follows. Since the lowered ribs have an outer surface which is recessed in relation to the rest of the outer surface of the profile when the tire is new and during a first phase of tread wear, the effective rolling radius of the tire is smaller in the region of these ribs and in free-rolling tires a constant braking force acts on the recessed ribs. As a result, these ribs are subject to greater and more uneven wear than the other dominant profile ribs, which exhibit significantly less, and especially even, wear.

The known circumferential groove combination have either unsatisfactory wet performance—for example in the case of combinations of two sipe-like, narrow circumferential grooves—or are unsatisfactory with regard to rolling resistance—if one or both circumferential grooves are comparatively wide and constructed in a manner similar to conventional circumferential grooves. Wide circumferential grooves result in a high void ratio, which has an unfavorable effect on tread stiffness.

The invention is based on the object of constructing, in a commercial vehicle tire of the type mentioned at the outset, a circumferential groove combination with a recessed rib which is advantageous for even wear and associated higher mileage in such a way that the rolling resistance is also kept low and the tire has good wet performance over its possible mileage.

The stated object is achieved according to the invention in that at least one of the two circumferential grooves of the circumferential groove combination is a circumferential groove which is composed, in the radial direction and in its course along the recessed rib, of a narrow groove portion that has an in particular constant width of 0.8 mm to 1.5 mm and of a channel-like widening that adjoins this groove portion, comprises the groove base and has a width, ascertained at its widest point, of 4.0 mm to 8.0 mm, in particular of 5.0 mm to 7.0 mm.

In treads designed according to the invention, the advantages of a circumferential groove combination provided with a recessed rib are combined with the advantages of circumferential grooves which, along the recessed rib and, as viewed in the radial direction from the outside to the inside, initially have a narrow groove portion and subsequently have a widening, i.e., an increased negative volume. In new or slightly worn treads, the recessed rib ensures uniform, mileage-improving wear and the tread is still particularly stiff due to the narrow groove portion, so that rolling resistance is also low. The widening along the groove base ensures good wet performance, in particular good wet braking properties. With increasing wear, the narrow groove portion “disappears”, the tread, with less rubber volume, becomes stiffer on its own and the widening that emerges ensures good wet performance even with a worn tread.

In a preferred embodiment, the tread has at least one circumferential groove combination, in which one circumferential groove is a circumferential groove having a channel-like widening in the region of the groove base, and the second circumferential groove is a sipe-like, narrow circumferential groove which has an in particular constant width of 0.80 mm to 4.00 mm, in particular up to 2.00 mm. Circumferential groove combinations of this type are advantageous for increased stiffness of the tread and are therefore provided in particular in the shoulder-side regions of the tread.

In a further advantageous embodiment variant of the invention, the tread has at least one circumferential groove combination, which consists of two circumferential grooves which have channel-like widenings in the region of the groove base and are in particular of identical design and arranged so as to be mirror-symmetrical to each other. Circumferential groove combinations constructed in this manner especially ensure a marked improvement in the wet performance of the tire.

The aforementioned effects of the circumferential groove combinations are intended to be substantially maintained over the service life of the tire or the region available for wear of the tread. In this respect, it is therefore preferred if the circumferential grooves having a channel-like widening and the sipe-like, narrow circumferential grooves of the respective circumferential groove combinations reach a depth of 6.00 mm to 17.00 mm, in particular 9.00 mm to 15.00 mm, in the radial direction, depending on the tire type and dimensions.

For good wet performance of the tire, it is in this case additionally advantageous if the channel-like widening, starting from its deepest point, has a height which is 35% to 50% of the depth of the circumferential groove having a channel-like widening.

A further measure which is advantageous for good wet performance is that the channel-like widening is, based on a central plane running through the sipe-like, narrow groove portion of the circumferential groove, of asymmetrical construction, wherein in this manner its cross-sectional area has two partial areas, wherein the partial area of the channel-like widening that is remote from the recessed rib is at least 10%, in particular up to 300%, greater than the second partial area. In this case, it is advantageous for even wear and the avoidance of tears in the region of the base of the channel-like widening if the partial area of the channel-like widening that is more remote from the recessed rib is outwardly rounded in a bulging manner throughout, at least over a region of the base and a region of the wall formed along the profile rib, and in particular with a circular arc with a radius of 2.00 mm to 4.00 mm.

Water drainage and the stiffness of the tread are further advantageously assisted if the narrow groove portion of the circumferential groove having the channel-like widening has a wall which runs along the adjacent profile rib and is adjoined at the level of the outer surface of the recessed rib by a rib flank which reaches the outer surface of the tread, and runs at an angle of 30° to 45° and in a manner pointing away from the recessed rib.

The main effect of the recessed rib, of ensuring uniform, mileage-improving wear in new or slightly worn treads, is particularly pronounced if the recessed rib has its greatest width in its region radially outside the widening and if the distance by which the outer surface of the recessed rib is offset radially inward in relation to the outer surface of the tread is 2.00 mm to 4.00 mm.

In a commercial vehicle tire comprising a tread with two shoulder-side profile ribs and at least two central profile ribs, it is particularly advantageous if at least one, in particular both, of the shoulder-side profile ribs is separated from the neighboring profile rib by a circumferential groove combination of a circumferential groove having a channel-like widening and a sipe-like, narrow circumferential groove, wherein the circumferential groove having the channel-like widening is adjacent to the shoulder-side profile rib. This measure ensures an effective balance, at the shoulder, between wet performance and tread stiffness. In this case, it is particularly advantageous if the channel-like widening is one that is outwardly rounded in a bulging manner throughout, at least over a region of the base and a region of the wall formed along the profile rib, and in particular with a circular arc with a radius of 2.00 mm to 4.00 mm.

In a commercial vehicle tire comprising a tread provided, as mentioned, with two shoulder-side profile ribs and at least two central profile ribs, it is further advantageous if central profile ribs are separated from one another by a circumferential groove combination of two circumferential grooves which have channel-like widenings and are in particular of identical design and arranged so as to be mirror-symmetrical to each other. In the central region of the tread, circumferential groove combinations constructed in this manner are particularly advantageous for striking a balance between profile stiffness and wet performance.

In a further preferred embodiment, in at least one circumferential groove combination, the recessed rib is divided into rib portions by transverse grooves, wherein the transverse grooves are formed at mutual distances of 10.00 mm to 20.00 mm, have a width of 1.00 mm to 2.00 mm and a depth of 50% to 80% of the depth of the circumferential groove having a channel-like widening. Transverse grooves of this type in the recessed ribs reduce the stiffness of the recessed ribs and may, depending on the position of the circumferential grooves in the tread, bring about an advantageous effect with regard to even wear.

Further features, advantages and details of the invention will now be described in more detail with reference to the schematic figures, which show exemplary embodiments of the invention. In the figures:

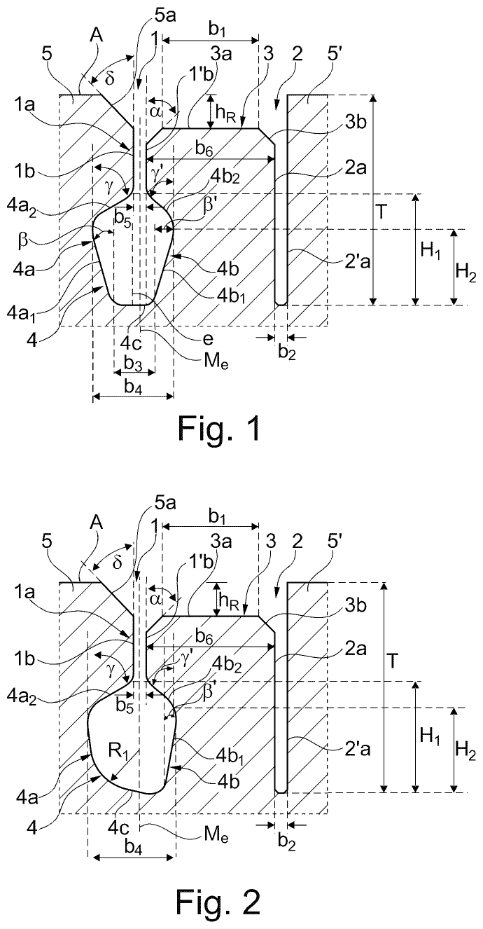

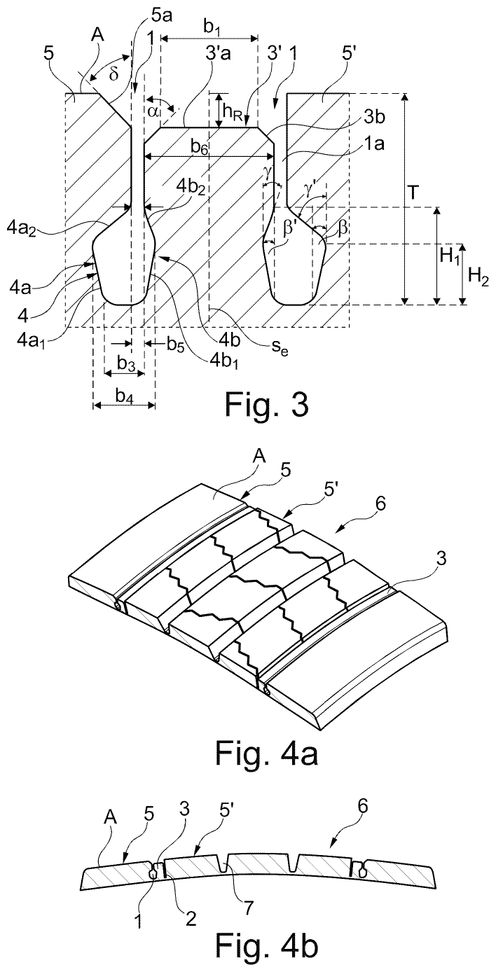

FIG. 1, FIG. 2 and FIG. 3 each show a cross section of an exemplary embodiment of a groove combination according to the invention,

FIG. 4a shows an oblique view of a circumferential portion of a tread of a pneumatic vehicle tire with an embodiment variant of the invention,

FIG. 4b shows a cross section of the tread from FIG. 4a,

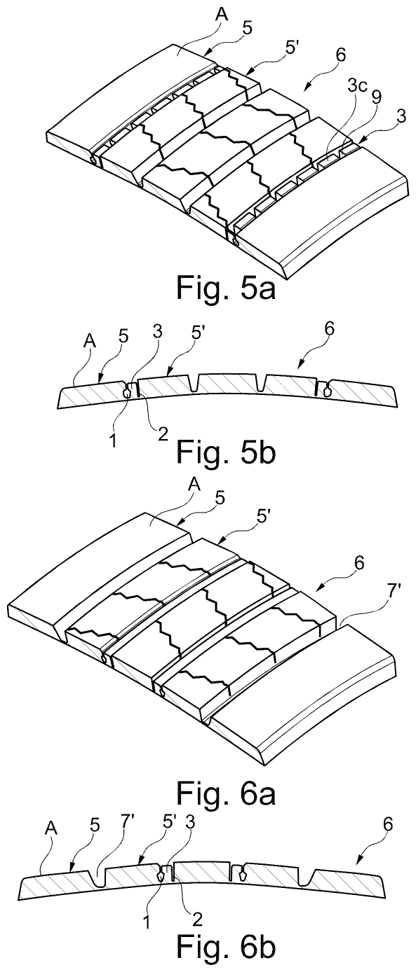

FIGS. 5a and 5b, FIGS. 6a and 6b, and FIGS. 7a and 7b show further variants of the invention in illustrations analogous to FIGS. 4a and 4b.

Tires designed according to the invention are commercial vehicle tires for multi-track motor vehicles, in particular commercial vehicle tires of radial configuration for trucks or buses, and for steering axles or non-driven axles and in particular for rims with rim diameters of 17.5, 19.5 or 22.5 inches. Commercial vehicle tires according to the invention are especially intended and are particularly well suited for operation on long journeys, i.e., on freeways, expressways and the like.

With reference to FIGS. 1 to 3, particularly advantageous embodiment variants of circumferential groove combinations for treads of the aforementioned commercial vehicle tires are described below. The term circumferential grooves refers to those grooves which run in the circumferential direction over the tread in either a straight or substantially straight manner, for example, in a wavy or zigzag shape with deviations of up to 10° from the circumferential direction.

FIGS. 1, 2 and 3 show cross sections of examples of circumferential groove combinations between two profile ribs 5, 5′ of a tread in a new tire. In all the figures of the drawings, A is used to denote the outer surface (positive surface), located outside the circumferential groove combinations, of the profile ribs 5, 5′ of the new tire.

The circumferential groove combinations shown in FIGS. 1 and 2 each have a first circumferential groove 1 with a channel-like widening 4 having the groove base, and a second, sipe-like, narrow circumferential groove 2. In the tread of the commercial vehicle tire, these circumferential groove combinations are arranged in particular in such a way that the first circumferential groove 1 adjoins a profile rib 5 which is located closer to the tire shoulder, and the second adjoins a profile rib 5′ which is located closer to the center of the tread. Running in the circumferential direction of the tread between the two circumferential grooves 1 and 2 is a recessed rib 3, referred to as a “sacrificial rib”, which has an outer surface 3a which runs parallel to the outer surface A and is offset radially inward in the radial direction in relation to the outer surface A by a distance h_{R}, wherein the distance h_{R} is 1.5 mm to 6.0 mm, in particular 2.0 mm to 4.0 mm. Both the first circumferential groove 1 having the channel-like widening 4, and the second, sipe-like, narrow circumferential groove 2 reach a depth T of 6.0 mm to 17.0 mm, in particular 9.0 mm to 15.0 mm, in the radial direction, wherein both circumferential grooves 1, 2 may have identical or differing depths T.

On its outer surface 3a, the recessed rib 3 has a width b₁ of 5.0 mm to 13.0 mm, in particular 7.0 mm to 13.0 mm. The two outer edge regions, running in the circumferential direction, of the recessed rib 3 are preferably beveled, i.e., provided with bevels 3b, in other words, narrow inclined surfaces, which run in an inclined manner in particular at an angle α of 35° to 50° relative to the radial direction.

The second, sipe-like, narrow circumferential groove 2 has sipe walls 2a, 2′a running in a radial direction and parallel to one another, wherein one sipe wall 2a is formed on the recessed rib 3 and the other is formed on the profile rib 5′ and reaches the outer surface A, and their mutual, in particular constant, distance corresponds to a width b₂ of 0.80 mm to 4.00 mm, in particular up to 2.00 mm.

In FIG. 1, the channel-like widening 4 in the first circumferential groove 1 is delimited by a base 4c and two opposing walls 4a and 4b, wherein the wall 4a is formed on the adjacent profile rib 5 and the wall 4b is formed on the recessed rib 3. The walls 4a, 4b are each composed of two wall portions 4a₁, 4a₂ and 4b₁, 4b₂, wherein 4a₁ and 4b₁ are respectively the two wall portions located further radially inward and adjoin the base 4c via rounded transition portions (not denoted). The base 4c has a width b₃, which is ascertained between the centers of the rounded transition portions adjoining the wall portions 4a₁ and 4b₁ and is 2.0 mm to 4.0 mm.

The radially inner wall portions 4a₁ and 4b₁ run in a mutually diverging, V-shaped manner and, respectively, at an angle β, β′ of 10° to 30° to the radial direction, wherein the angles β, β′ may be equal, but in particular the angle β is greater than the angle β′ by up to 10°, in particular by at least 5°. The wall portions 4a₂ and 4b₂ adjoin the former, via further rounded transition portions, at angles y, y′ of 10° to 70° to the radial direction in such a way that they run toward each other, reducing the width of the channel-like widening 4. The angles y, y′ may be equal; in particular, the angle y is 5° to 10° greater than the angle y′.

In the case of differing angles β, β and y, y′, the channel-like widening 4 is of asymmetrical construction based on a plane e running in the radial direction through the center of the base 4c.

In the radial direction, starting from its deepest point, the widening 4 has a height H₁ which is 35% to 50% of the depth T. The wall portions 4a₁ and 4b₁ extend in the radial direction up to a height H₂ of 60% to 70% of the height H₁. In the region of the rounded transition portions between the wall portions 4a₁, 4a₂ and 4b₁, 4b₂, the widening 4 has its greatest width b₄, wherein b₄ is 4.0 mm to 8.0 mm, in particular 5.0 mm to 7.0 mm.

The radially outer wall portions 4a₂ and 4b₂ are adjoined, via rounded transition portions, by walls 1b, 1′b of a groove portion 1a, these walls running parallel to one another and in the radial direction, wherein this groove portion 1a, the wall 1b′ of which runs along the recessed rib 3 and the wall 1b of which runs along the adjoining profile rib 5, has an in particular constant width b₅ of 0.8 mm to 1.5 mm, in particular up to 1.2 mm. Starting from the aforementioned wall portion 4a₂, the wall 1b runs in the radial direction up to the level of the outer surface 3a of the recessed rib 3. The wall 1b is adjoined by a rib flank 5a which reaches the outer surface A and extends at an angle δ 30° to 45°, widening the recess present throughout the tread by the recessed rib 3.

In the region of its radial extent between the groove portion 1a of the first circumferential groove 1 and the second sipe-like, narrow circumferential groove 2, the recessed rib 3 has a width b₆ of 6.0 mm to 14.0 mm, in particular 8.0 mm to 12.0 mm.

In the embodiment shown in FIG. 2 of the circumferential groove combination, the second sipe-like, narrow circumferential groove 2 and the recessed rib 3b are constructed in accordance with the design described with regard to FIG. 1, as are the groove portion 1a of the first circumferential groove 1 and the wall portions 4b₁, 4b₂ and 4a₂ of the widening 4. The reference numerals selected in FIG. 1 have therefore been adopted, and the description has not been repeated. The channel-like widening 4 is outwardly rounded in a bulging manner throughout, i.e., continuously, over at least a region of the base 4c and to the wall portion 4a₂. The rounded portion preferably takes the form of a circular arc with a radius R₁ of 2.0 mm to 5.0 mm, preferably in the order of 4.0 mm.

The channel-like widening 4 is thus of asymmetrical construction based on a central plane Mₑ (marked in FIGS. 1 and 2) running through the sipe-like, narrow groove portion 1a. The cross-sectional area is divided into two partial areas by the central plane Mₑ, wherein the partial area of the channel-like widening 4 that is more remote from the recessed rib 3 is at least 10%, in particular up to 300%, greater than the second partial area.

FIG. 3 shows a design of a circumferential groove combination of two circumferential grooves 1 which are separated from each other by a recessed rib 3′ and are designed as described with regard to FIG. 1, or alternatively as described with regard to FIG. 2. The numbering is adopted accordingly, with no description provided. The two circumferential grooves 1 are mutually arranged so as to be mirror-symmetrical to each other, so that the recessed rib 3′ has a plane Sₑ of symmetry running centrally in the radial direction. Analogously to FIG. 1, the greatest width be of the rib 3′ is 6.0 mm to 14.0 mm, in particular 8.0 mm to 12.0 mm.

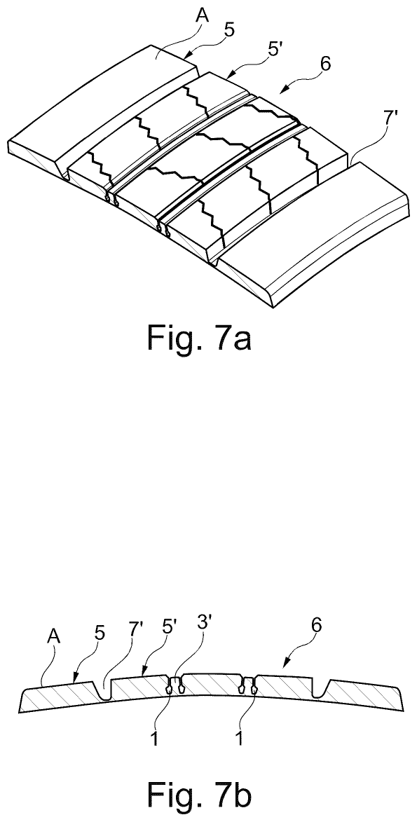

FIG. 4a with FIG. 4b, FIG. 5a with FIG. 5b, FIG. 6a with FIG. 6b and FIG. 7a with FIG. 7b respectively show circumferential portions and cross sections of a tread 6 with five profile ribs 5, 5′ running in an encircling manner in the circumferential direction, wherein the profile ribs 5 are the two profile ribs running on the shoulder side and the profile ribs 5′ are the three profile ribs running between the shoulder-side profile ribs 5.

In the design shown in FIGS. 4a and 4 b, the shoulder-side profile ribs 5 are separated from their neighboring profile ribs 5′ by a circumferential groove combination as shown in FIG. 2. The circumferential grooves 1 are adjacent to the shoulder-side profile ribs 5. The two circumferential grooves 7 provided in the central region of the tread 6 are, in particular, conventionally designed circumferential grooves. In addition, the three central profile ribs 5′ are divided in a profile-block-like manner by narrow grooves or sipes 8 which run, in plan view, in a zigzag shape.

FIGS. 5a and 5b show a variant of the tread construction shown in FIGS. 4a and 4b. The recessed ribs 3 formed in the two circumferential groove combinations running on the shoulder side are divided in the circumferential direction into rib portions 3c by transverse grooves 9 running in the axial direction. The transverse grooves are formed at mutual distances of 10.0 mm to 20.0 mm, have a width of 1.0 mm to 2.0 mm and a depth which is 50% to 80% of the depth T.

FIGS. 6a and 6b show a design in which the central profile rib of the three profile ribs 5′ is separated from the neighboring profile ribs 5′ by circumferential groove combinations according to FIG. 1. The two circumferential grooves 7′ running next to the shoulder-side profile ribs 5 are, in particular, conventionally designed shoulder-side circumferential grooves with approximately V-or U-shaped cross sections.

FIGS. 7a and 7b show a design of a tread 6, in which with the central profile rib of the central profile ribs 5′ are separated from the neighboring central profile ribs 5′ by circumferential groove combinations according to FIG. 3. The circumferential grooves 7′ running on the shoulder side correspond to those according to FIGS. 6a and 6b.

### LIST OF REFERENCE SIGNS

1 . . . First circumferential groove
1a . . . Channel portion
1b, 1′b . . . Wall
2 . . . Second circumferential groove
2a, 2′a . . . Sipe wall
3, 3′ . . . Recessed rib
3a, 3′a . . . Outer surface
3b . . . Bevel
3c . . . Rib portion
4 . . . Widening
4a, 4b . . . Wall
4a₁, 4b₁ . . . Wall portion
4a₂, 4b₂ . . . Wall portion
4c . . . Base
5, 5′ . . . Profile rib
5a . . . Rib flank
6 . . . Tread
7, 7′ . . . Circumferential groove
8 . . . Sipe
9 Transverse groove
α . . . Angle (bevel 3b)
β . . . Angle (wall portion 4a₁)
β′ . . . Angle (wall portion 4b₁)
γ . . . Angle (wall portion 4a₂)
γ′ . . . Angle (wall portion 4b₂)
δ . . . Angle (rib flank 5a)
A . . . Outer surface (profile ribs 5, 5′)
b₁ . . . Width (outer surface of rib 3)
b₂ . . . Width (circumferential groove 2)
b₃ . . . Width (base 4c)
b₄ . . . Width (widening 4)
b₅ . . . Width (groove portion 1a)
b₆ . . . Width (rib 3)
e . . . Plane
H₁ . . . Height (widening 4)
H₂ . . . Height (wall portions 4a₁, 4b₁)
h_{R} . . . Distance (rib 3 to outer surface A)
Mₑ . . . Central plane
R₁ . . . Radius
sₑ . . . Plane of symmetry
T . . . Depth

1. A commercial vehicle tire comprising a profiled tread with profile ribs having an outer surface forming the positive surface, and with circumferential grooves which extend in an encircling manner in the circumferential direction and form the main grooves of the tread, wherein running at least between two profile ribs is a circumferential groove combination of two circumferential grooves which are separated from each other by a recessed rib which has an outer surface that is radially inwardly offset in relation to the outer surface of the tread by a distance of 1.5 mm to 6.0 mm and which has, at its widest point, a width of 6.00 mm to 14.00 mm,
wherein:
at least one of the two circumferential grooves of the circumferential groove combination is a circumferential groove which is composed, in the radial direction and in its course along the recessed rib, of a narrow groove portion that has a width of 0.8 mm to 1.5 mm and of a channel-like widening that adjoins this groove portion, comprises the groove base and has a width ascertained at its widest point, of 4.0 mm to 8.0 mm.

2. The commercial vehicle tire as claimed in claim 1, wherein the tread has at least one circumferential groove combination, in which one circumferential groove is a circumferential groove having a channel-like widening in the region of the groove base and the second circumferential groove is a sipe-like, narrow circumferential groove which has a constant width of 0.8 mm to 4.0 mm.

3. The commercial vehicle tire as claimed in claim 1, wherein the tread has at least one circumferential groove combination, which consists of two circumferential grooves which have channel-like widenings in the region of the groove base and are in particular of identical design and arranged so as to be mirror-symmetrical to each other.

4. The commercial vehicle tire as claimed in claim 1, wherein each circumferential groove having a channel-like widening and each sipe-like, narrow circumferential groove reaches a depth of 6.0 mm to 17.0 mm, in particular 9.0 mm to 15.0 mm, in the radial direction.

5. The commercial vehicle tire as claimed in claim 1, wherein the channel-like widening, starting from its deepest point, has a height which is 35% to 50% of the depth of the circumferential groove having a channel-like widening.

6. The commercial vehicle tire as claimed in claim 1, wherein the channel-like widening is, based on a central plane running through the sipe-like, narrow groove portion of the circumferential groove, of asymmetrical construction and in this manner its cross-sectional area has two partial areas, wherein the partial area of the channel-like widening that is remote from the recessed rib is at least 10%, in particular up to 300%, greater than the second partial area.

7. The commercial vehicle tire as claimed in claim 6, wherein the partial area of the channel-like widening that is more remote from the recessed rib is outwardly rounded in a bulging manner throughout, at least over a region of the base and a region of the wall formed along the profile rib, and in particular with a circular arc with a radius of 2.0 mm to 4.0 mm.

8. The commercial vehicle tire as claimed in claim 1, wherein the narrow groove portion of the circumferential groove having the channel-like widening has a wall which runs along the adjacent profile rib and is adjoined at the level of the outer surface of the recessed rib by a rib flank which reaches the outer surface of the tread, and runs at an angle of 30° to 45° and in a manner pointing away from the recessed rib.

9. The commercial vehicle tire as claimed in claim 1, wherein the recessed rib has its greatest width in its region radially outside the widening(s).

10. The commercial vehicle tire as claimed in claim 1, wherein the distance by which the outer surface of the recessed rib is offset radially inward in relation to the outer surface of the tread is 2.0 mm to 4.0 mm.

11. The commercial vehicle tire as claimed in claim 1, comprising a tread with two shoulder-side profile ribs and at least two central profile ribs, characterized in that at least one, in particular both, of the shoulder-side profile ribs is separated from the neighboring profile rib by a circumferential groove combination of a circumferential groove having a channel-like widening, and a sipe-like, narrow circumferential groove, wherein the circumferential groove having the channel-like widening is adjacent to the shoulder-side profile rib.

12. The commercial vehicle tire as claimed in claim 6, wherein the channel-like widening is one that is outwardly rounded in a bulging manner throughout, at least over a region of the base and a region of the wall formed along the profile rib, and in particular with a circular arc with a radius of 2.0 mm to 4.0 mm.

13. The commercial vehicle tire as claimed in claim 1, comprising a tread with two shoulder-side profile ribs and at least two central profile ribs, characterized in that central profile ribs are separated from one another by a circumferential groove combination of two circumferential grooves which have channel-like widenings and are in particular of identical design and arranged so as to be mirror-symmetrical to each other.

14. The commercial vehicle tire as claimed in claim 1, wherein, in at least one circumferential groove combination, the recessed rib is divided into rib portions by transverse grooves, wherein the transverse grooves are formed at mutual distances of 10.0 mm to 20.0 mm, have a width of 1.0 mm to 2.0 mm and a depth of 50% to 80% of the depth of the circumferential groove having a channel-like widening.
